(19) United States
(12) Patent Application Publication
(10) Pub. No.: US 2013/0259453 A1
(43) Pub. Date: Oct. 3, 2013

(54) SYSTEM AND METHOD FOR FILTERING SHARED VIDEO CONTENT

(71) Applicant: Ivo J. Van de Griend, Den Haag (NL)

(72) Inventor: Ivo J. Van de Griend, Den Haag (NL)

(21) Appl. No.: 13/693,448

(22) Filed: Dec. 4, 2012

Related U.S. Application Data
(60) Provisional application No. 61/616,033, filed on Mar. 27, 2012.

(51) Int. Cl. H04N 9/87

(52) U.S. Cl. CPC H04N 9/87
USPC 386/353

(57) ABSTRACT

The present invention generally relates to the filtering of shared video content. Specifically, this invention relates to a computer implemented system and method for filtering shared video content based on identifiable characteristics of the video content denoting the video as either “real” or “computer-generated.”

### CROSS REFERENCE TO RELATED APPLICATIONS

This application claims the benefit of U.S. Provisional Patent Application No. 61/616,033 filed Mar. 27, 2012, the entire disclosure of which is incorporated herein by reference.

### FIELD OF THE INVENTION

The present invention generally relates to the filtering of shared video content. Specifically, this invention relates to a computer implemented system and method for filtering shared video content based on identifiable characteristics of the video content denoting the video as either “real” or “computer-generated.”

### BACKGROUND

Search results on video-sharing websites are increasingly being “polluted” by video images recorded from computer games. These computer-generated videos can create a negative user experience, as they tend not to be clearly labeled as originating from a computer game and can often not be recognized as such by looking at the thumbnails. This is due to the high quality of many game graphics.

Filters are currently in place at various websites to optimize the search results based on language preference, location etc, but no filters have been encountered which can filter out computer-generated images.

Therefore, there is need in the art for a system and method configured to provide filtering of shared video content based on identifiable characteristics of the video content, denoting the video as either “real” or “computer-generated.” These and other features and advantages of the present invention will be explained and will become obvious to one skilled in the art through the summary of the invention that follows.

### SUMMARY OF THE INVENTION

Accordingly, it is an aspect of the present invention to provide a system and method for the filtering of shared video content whereby the filter can identify computer-generated video content.

According to an embodiment of the present invention, a system for filtering shared video content, the system includes a video filtering module comprising physical memory storing instructions that cause the video filtering module to: receive one or more preferences related to the processing of a video, analyze the video, wherein one or more still frames of the video are analyzed to identify a video source of the video, wherein the video source is selected from the group including real video sources and computer-generated video sources, and verify the video source, wherein the video source is stored as video source information to enable efficient processing when utilized in relation to sorting of groups of videos.

According to an embodiment of the present invention, the video filtering module may further provide a user interface to a user, wherein the user interface offers the user one or more preferences for the processing of the video.

According to an embodiment of the present invention, the video filtering module may further process the groups of videos by sorting the groups of videos according to the one or more preferences selected by the user.

According to an embodiment of the present invention, the video filtering module may further return a video results list to the user, wherein the video results list is comprised of a subset of videos from the groups of videos that match the one or more preferences selected by the user.

According to an embodiment of the present invention, the system further includes one or more frame grabbing software components, wherein the one or more frame grabbing software components are configured to capture the one or more still frames from the video.

According to an embodiment of the present invention, the system further includes a file communications module configured to affect the transfer of the video source information from one or more source locations and the video filtering module.

According to an embodiment of the present invention, the system further includes one or more image verification software components configured to identify the source of the one or more still frames of the video, wherein the one or more image verification software components identify the one or more still frames as computer generated or real.

According to an embodiment of the present invention, the system further includes a results communications module configured to provide the video results list to the user or a video-sharing website.

According to an embodiment of the present invention, a method for filtering shared video content, the method comprises the steps of: receiving one or more preferences related to the processing of a video, analyzing the video, wherein one or more still frames of the video are analyzed to identify a video source of the video and wherein the video source is selected from the group including real video sources and computer-generated video sources, and verifying the video source, wherein the video source is stored as video source information to enable efficient processing when utilized in relation to sorting of groups of videos.

According to an embodiment of the present invention, the method further includes the step of providing a user interface to a user, wherein the user interface offers the user one or more preferences for the processing of the video.

According to an embodiment of the present invention, the method further includes the step of processing the groups of videos, wherein the groups of videos are sorted according to the one or more preferences selected by the user.

According to an embodiment of the present invention, the method further includes the step of compiling a video results list, wherein the video results list is comprised of a subset of videos from the groups of videos that match the one or more preferences selected by the user.

According to an embodiment of the present invention, the method further includes the step of analyzing the one or more still frames of the video in a fixed order, wherein the fixed order may be determined by an algorithm.

According to an embodiment of the present invention, the method further includes the step of analyzing the one or more still frames of the video in a random order, wherein the random order helps to prevent deception.

According to an embodiment of the present invention, the method further includes the step of analyzing the video on a local computing device.

According to an embodiment of the present invention, the method further includes the step of sending the video across one or more networks to be analyzed on a remote computing device.

### BRIEF DESCRIPTION OF THE DRAWINGS

FIG. 1 illustrates a schematic overview of a computing device, in accordance with an embodiment of the present invention;

FIG. 2 illustrates a network schematic of a system in accordance with an embodiment of the present invention;

FIG. 3 illustrates a process flow of an exemplary method, in accordance with an embodiment of the present invention; and

FIG. 4 illustrates a process flow of an exemplary method, in accordance with an embodiment of the present invention.

### DETAILED SPECIFICATION

The present invention generally relates to the filtering of shared video content. Specifically, this invention relates to a computer implemented system and method for filtering shared video content based on identifiable characteristics of the video content denoting the video as either “real” or “computer-generated.”

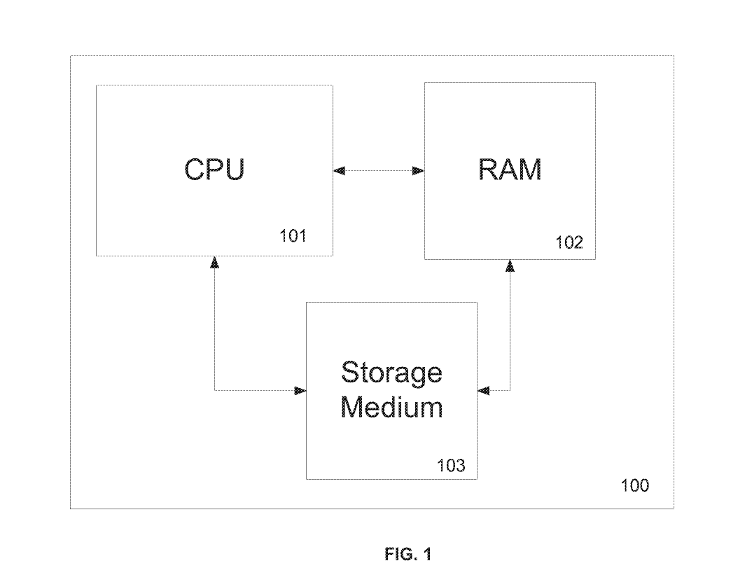

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, and a storage medium (e.g., hard disk drive, solid state drive, flash memory, cloud storage) 103. Examples of computing devices usable with embodiments of the present invention include, but are not limited to, personal computers, smart phones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention a user may be able to compose data offline that will be consumed by the system when the user is later connected to a network.

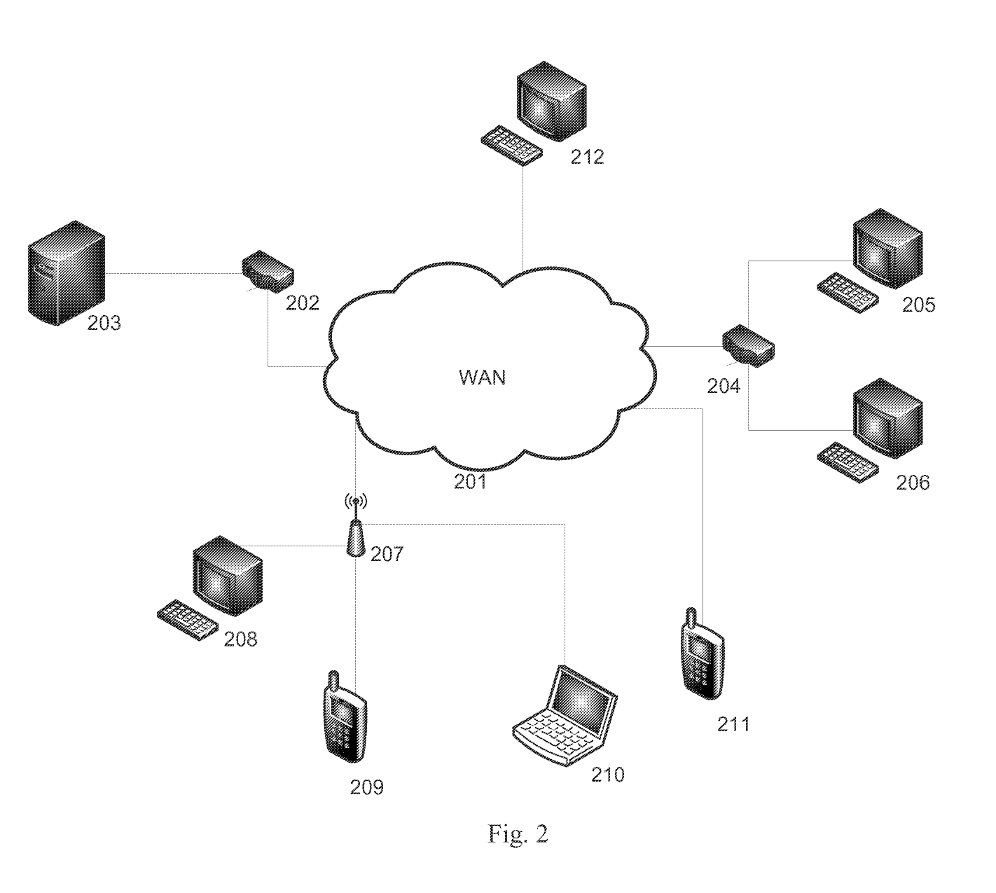

Referring to FIG. 2, a schematic overview of a system in accordance with an embodiment of the present invention is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 2, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via WAN 201 or other network in numerous ways. For instance, a component may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art would appreciate that there are numerous ways that a component may connect to server 203 via WAN 201 or other network, and embodiments of the present invention are contemplated for use with any method for connecting to server 203 via WAN 201 or other network. Furthermore, server 203 could be comprised of a personal computing device, such as a smartphone, acting as a host for other computing devices to connect to. While many components of the system are web-based or otherwise utilize computing devices over networks, such as the internet, certain aspects of the invention may be provided by analog systems (e.g., landline telephones could be utilized to call and leave voicemails which may be digitized and converted into useable components within the system).

According to an embodiment of the present invention, the system and methods described herein are configured to filter results provided by video-sharing websites (e.g., YouTube, VIMEO) in order to identify and remove computer-generated videos. In this regard, embodiments of the present invention may include: a Graphical User Interface (GUI) component that allows a user to select one or more preferences in relation to computer-generated material; one or more frame-grabbing software components that are configured to capture one or more still frames from provided video content (e.g., search results provided by a video-sharing website); a file communications module configured to affect the transfer of frame data and/or video data from one or more source locations and the system; one or more image verification software components that are configured to identify the source of a still frame; and a results communications module configured to provide the results to a user or video-sharing website. While a preferred embodiment of the present invention may be comprised of all of the aforementioned components, alternative embodiments may have fewer or a greater number of components or alternatively have certain components replaced with suitable alternatives for said component.

According to an embodiment of the present invention, the GUI component is configured to allow one or more users the ability to input and receive data in a human-readable format. The GUI may, for instance, be displayed on a human readable display component (e.g., monitor, TV) and may be configured to provide the user the ability to provide information to the system in order to allow the system to process information desired by the user. In a preferred embodiment of the present invention, the GUI is configured to allow the user to select preferences in relation to computer-generated material and affect a search of video content. Preferences include, but are not limited to, whether the user wants to filter “computer generated” content, whether the user wants to filter “real” content, specifics related to the content (e.g., genre, age appropriateness, duration, quality, bitrate). One of ordinary skill in the art would appreciate that there are numerous types of preferences that may be utilized with embodiments of the present invention, and embodiments of the present invention are contemplated for use with any type of preference.

According to an embodiment of the present invention, the one or more frame-grabbing software components of the system are configured to capture one or more still frames from provided video content. Video content may be located locally and retrieved from a storage medium operatively connected to one or more computing devices of the system or video content may be located remotely from the system and provided to the system via one or more networks. Once the video is received, the frame-grabbing software components may be configured to grab one or more frames from the video content. The frames grabbed may be random or may be selected from some other pattern (e.g., first frame, mid-point frame, certain frame numbers). In certain embodiments, algorithms may be utilized to select the particular one or more frames to grab. In this manner, the system can be configured to prevent spoofing or scamming of the system by placing real or computer generated frames at specific locations of the video in order to fool embodiments of the system.

According to an embodiment of the present invention, the file communications module is configured to affect the transfer of frame data and/or video data to/from one or more source locations and the system. The file communications module may be configured to retrieve or otherwise receive and transfer the data locally for processing on a processor located at the computing device the file communications module resides on or it may transfer the data remotely across one or more networks to be processed at a remote computing device. One of ordinary skill in the art would appreciate that there are numerous manners in which the file communications module may operate, and embodiments of the present invention are contemplated for use with any method for transferring data to appropriate locations.

According to an embodiment of the present invention, one or more image verification software components are configured to identify the source of a still frame. In a preferred embodiment of the present invention, the image verification software components are configured to identify whether a still frame of a video was generated by a computer (i.e., computer generated) or real (i.e., generated via a camera operated in the real-world and recording live or otherwise viewed events). For each video, the image verification software components may be configured to identify the source of one or more still frames of the video in order to make a full analysis of the source of the video (e.g., real or computer generated). In certain embodiments, the more still images/frames of a video analyzed, the more accurate the prediction of the source of the video. In other embodiments, a single frame may be analyzed to determine the source of a video.

According to an embodiment of the present invention, a results communications module is configured to provide the results to a user or video-sharing website. The results communications module may be the same as the file communications module or an independent module and configured to share results with a local computing device or one or more remote computing device located across one or more networks. One of ordinary skill in the art would appreciate that there are numerous types of results communications modules that may be utilized with embodiments of the present invention, and embodiments of the present invention are contemplated for use with any type of results communications module. Once the results are communicated to the appropriate computing device, information regarding the one or more videos analyzed by the system may be stored or otherwise kept in relation to the videos analyzed. For instance, meta data identifying whether the source of the video as well as any other relevant data (e.g., how many frames were analyzed) may be stored or otherwise made available and associated with the video.

According to embodiments of the present invention, the system may be engaged at various times, depending on the particular setup and as desired by the users and operators of the system. For instance, the system could be configured to automatically analyze videos as they are uploaded to a server or other computing device. In alternate embodiments, videos returned in a search may be analyzed if no previous meta data or other information regarding the source of the video is associated with the particular video.

According to an embodiment of the present invention, the system may be configured to process one video at a time or process multiple videos in bulk or batch.

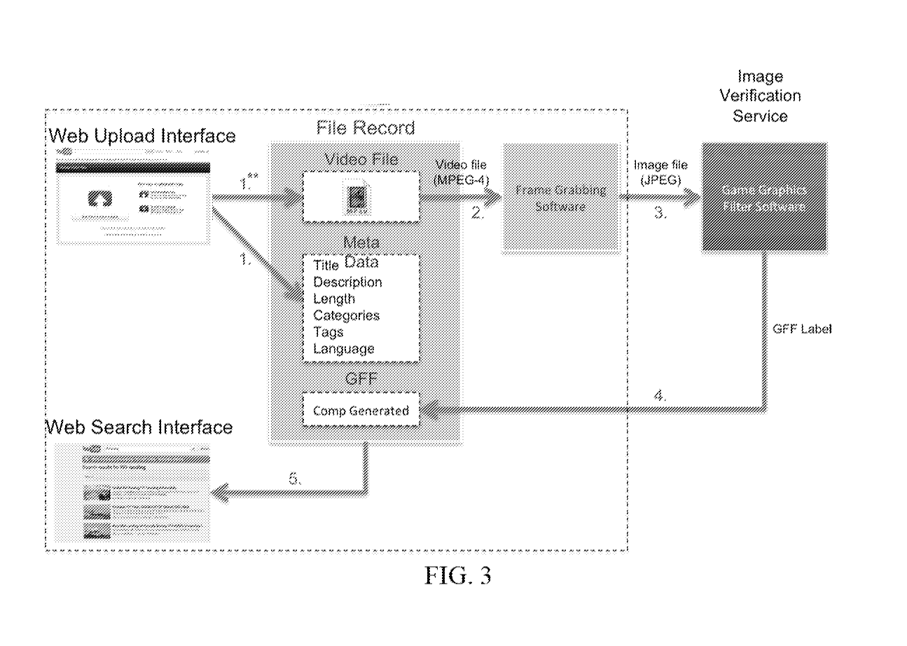

Turning now to FIG. 3, an exemplary embodiment of the present invention is shown. In this embodiment, the system is configured to allow a user to upload one or more videos and related descriptions/meta tags to video-sharing website's server. At this point, a frame-grabbing software component of the system is configured to automatically select a single frame from the video and save it as an image. The image is automatically transferred (individually or in bulk) to a server of an image verification service provider. The image is then analyzed by image verification software component of the system and categorized as either “computer-generated” or “real.” This information (e.g., in the form of a metadata tag) is communicated back to the server of the video-sharing website and stored in the file record of the related video. The system is configured to allow the user to then perform a search on the video-sharing website, whereby the user is presented with search results, which, depending on the user's previous selection, either include or exclude information on computer-generated videos.

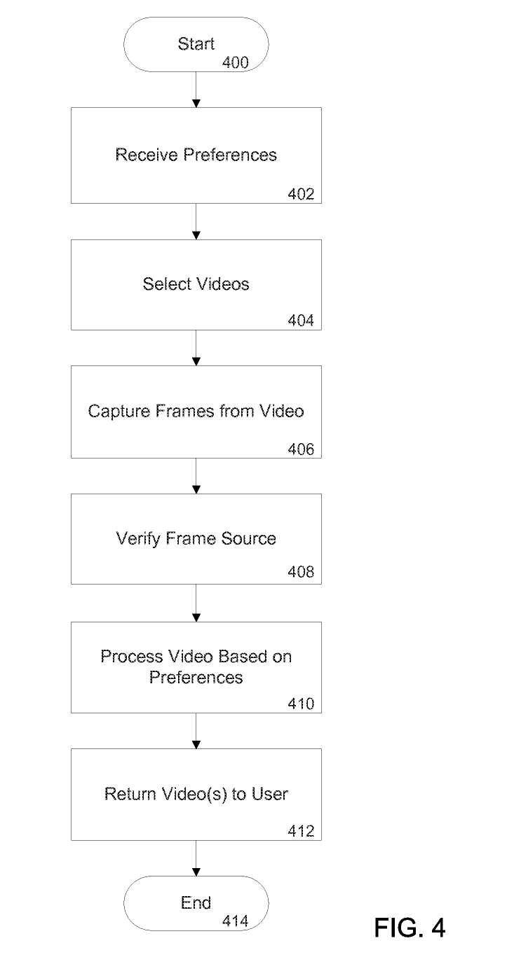

Turning now to FIG. 4, an exemplary embodiment of the present invention is shown. The process starts at step 400. At step 402, the system receives preferences to be utilized in the processing of the videos. As discussed above, preferences may include whether the user wishes to view only real videos, only computer generated videos or any combination thereof.

At step 404, the system selects the videos to be reviewed and analyzed. This may be done at the time a user has submitted a search for certain video content or other at any other time (e.g., at the time a video is being uploaded to the system). As described above, there may be certain instances where one or more videos have previously been analyzed. The previously analyzed videos may be skipped by the system during the present analyzing step if so configured to do so.

At step 406, the system captures frames from the video. Depending on the system, one or more frames may be captured in any of the various manners described above. If the system is configured to send the video to an external source for processing, this may occur at step 406 as well.

At step 408, the system verifies the source of the one or more frames provided. As each frame is verified, the system stores relevant data associated with the frame, including its source.

At step 410, the system processes the videos based on the previously provided preferences. This may include removing videos that do not meet certain criteria or forming a subset of videos that should be returned to a user or otherwise organized as appropriate. At step 412 the appropriate videos are returned to the user and the process terminates at step 414.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more threads. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for filtering shared video content, the system comprising:
a video filtering module comprising physical memory storing instructions that cause the video filtering module to:
receive one or more preferences related to the processing of a video;
analyze said video, wherein one or more still frames of said video are analyzed to identify a video source of said video,
wherein said video source is selected from the group comprising real video sources and computer-generated video sources; and
verify said video source; wherein said video source is stored as video source information to enable efficient processing when utilized in relation to sorting of groups of videos.

2. The system of claim 1, wherein said video filtering module may further provide a user interface to a user, wherein said user interface offers said user said one or more preferences for the processing of said video.

3. The system of claim 1, wherein said video filtering module may further process said groups of videos by sorting said groups of videos according to said one or more preferences selected by said user.

4. The system of claim 1, wherein said video filtering module may further return a video results list to said user, wherein said video results list is comprised of a subset of videos from said groups of videos that match said one or more preferences selected by said user.

5. The system of claim 1 further comprising one or more frame grabbing software components, wherein said one or more frame grabbing software components are configured to capture said one or more still frames from said video.

6. The system of claim 1 further comprising a file communications module configured to affect the transfer of said video source information from one or more source locations and said video filtering module.

7. The system of claim 1 further comprising one or more image verification software components configured to identify the source of said one or more still frames of said video, wherein said one or more image verification software components identify said one or more still frames as computer generated or real.

8. The system of claim 4 further comprising a results communications module configured to provide said video results list to said user or a video-sharing website.

9. A method for filtering shared video content, the method comprising the steps of:
receiving one or more preferences related to the processing of a video;
analyzing said video, wherein one or more still frames of said video is analyzed to identify a video source of said video,
wherein said video source is selected from the group comprising real video sources and computer-generated video sources; and
verifying said video source; wherein said video source is stored as video source information to enable efficient processing when utilized in relation to sorting of groups of videos.

10. The method of claim 9, further comprising the step of providing a user interface to a user, wherein said user interface offers said user said one or more preferences for the processing of said video.

11. The method of claim 9, further comprising the step of processing said groups of videos, wherein said groups of videos is sorted according to said one or more preferences selected by said user.

12. The method of claim 9, further comprising the step of compiling a video results list, wherein said video results list is comprised of a subset of videos from said groups of videos that match said one or more preferences selected by said user.

13. The method of claim 9, further comprising the step of analyzing said one or more still frames of said video in a fixed order, wherein said fixed order may be determined by an algorithm.

14. The method of claim 9, further comprising the step of analyzing said one or more still frames of said video in a random order, wherein said random order helps to prevent deception.

15. The method of claim 9, further comprising the step of analyzing said video on a local computing device.

16. The method of claim 9, further comprising the step of sending said video across one or more networks to be analyzed on a remote computing device.
